(19) United States
(12) Patent Application Publication
(10) Pub. No.: US 2008/0047412 A1
(43) Pub. Date: Feb. 28, 2008

(54) System for teaching chords, transcribing music and a musical conversion method

(76) Inventor: Sylvain Lalonde, Blainville (CA)

Correspondence Address: INVENTARIUM, SUITE 1607, 4050 ROSEMONT, MONTREAL, QC, H1X 1M4, US

(21) Appl. No.: 11/767,505

(22) Filed: Jun. 23, 2007

Related U.S. Application Data
(60) Provisional application No. 60/839,658, filed on Aug. 24, 2006.

(51) Int. Cl. G10G 3/04

(52) U.S. Cl. 84/462

(57) ABSTRACT

A musical conversion table that uses a new paradigm in understanding music. Most people understand that there are seven notes to an octave and anyone who has seen a keyboard such as a piano has noticed that besides the white keys, there are also black keys. There are in fact 5 black keys for each 7 white keys. This gives a total of twelve notes, not 7 as music has always been teach. This is what complicates matters. In order to simplify matters, this inventor has decided that there are 12 notes. Moreover, this inventor has found a relation between what is known as the <<divine proportion>>, which can be represented by the Fibonacci sequence and the music scale.

This application claims priority based on provisional application 60/839,658 filed Aug. 24, 2006

### FIELD OF THE INVENTION

The present invention relates generally to music but more particularly to a new system for teaching chords and transcribing music.

### BACKGROUND OF THE INVENTION

Teaching music is a complicated endeavor and over the years, many inventors have devised tools such as tables, slide rules and wheels to try to find an easy way for musicians to figure out chords and how to transpose chords to different keys.

These devices or systems require lessons and a lot of practice to figure out how to make them work and there is therefore a need for a more practical way of teaching music.

In western culture, the system rests on a heptatonic scale, composes of 5 tones and 2 semitones. This succession of tone and semitones bears the name of diatonism. The 7 basic sounds are C, D, E, F, G, A, B, both semitone is between B-C and E-F.

This system is problematic when one wants to change “keys” to accommodate for example a singer who sings on a different key. A complicated work of transposing the music partition onto the new key is required.

This music theory is very complex and not all musicians find it easy to understand. In fact, it requires a mathematical mind to do it with ease when in fact, a lot of musicians are more artisitically minded rather than mathematically minded.

### SUMMARY OF THE INVENTION

In view of the foregoing disadvantages inherent in the known devices now present in the prior art, the present invention, which will be described subsequently in greater detail, is to provide the object and advantage which is:

To provide a simple system and method that can be taught easily and used easily as well after a very short tutorial, as simple as an instruction sheet provided along with one of several of the embodiment the invention comes in such as a table, a slide rule, a rotary wheel, a hand held electronic calculator and even computer software to give out chords and transpose them to different keys.

In order to do so, the invention uses a new paradigm in understanding music. Most people understand that there are seven notes to an octave and anyone who has seen a keyboard such as a piano has noticed that besides the white keys, there are also black keys. There are in fact 5 black keys for each 7 white keys. This gives a total of twelve notes, not 7 as music has always been taught. This is what complicates matters. In order to simplify matters, this inventor has decided that there are 12 notes. Moreover, this inventor has found a relation between what is known as the <<divine proportion>>, which can be represented by the Fibonacci sequence and the music scale.

The musical conversion system that can be embodied into a structure such as a table, a slide rule, a rotary wheel, a hand held electronic calculator, or computer hardware with software written according to said musical conversion system so as to transform musical chords and transcribing chords or music to different keys and which has a mode of operation described by the following sequence: Using Fibonacci's sequence of 1, 3, 5, 8, and 13 on a western conventional musical scale which provides the advantage of being able to use any key a still keep the same spacing between physical notes on a sheet of music or musical instrument.

This method uses the tempered scale which has twelve evenly spaced tones. By using this method, it is possible to create teaching aids that are simple to make and easy to use.

For example, when the musical conversion system is in the form of a slide rule, it has the method of use consisting of the steps of starting on any key, the spacing is always the same on the slide rule with a body and a cursor. The cursor is positioned on a user selected note which automatically positions the other windows located on the cursor to show the other notes of the chord which are located on the body.

Another example is when the musical conversion system is in the form of a rotary wheel having with the method of use consisting of the steps of starting on any key, the spacing is always the same on the wheel with a fixed disc and a rotating disc. The rotating disc is positioned on a user selected note which automatically positions the other windows to show the other notes of the chord which are located on the fixed disc.

Generally speaking, any of the above mentioned embodiments is used for enabling the transformation of musical chords and transcribing the chords or music to different keys with the use of Fibonacci's sequence of 1, 3, 5, 8, and 13 on a western conventional musical scale and by selecting a musical note, the remaining notes of the chord are indicated on the embodiment which instantly gives the correct notes for the newly selected key the piece of music is to be played.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 table showing the scale transposing.

FIGS. 2abc slide rule components and slide rules assembled and showing the cursor at two different positions, respectively.

FIGS. 3abc wheel showing the disc at two different positions.

FIGS. 4abc representations of a new universal musical notation scale.

### DETAILED DESCRIPTION

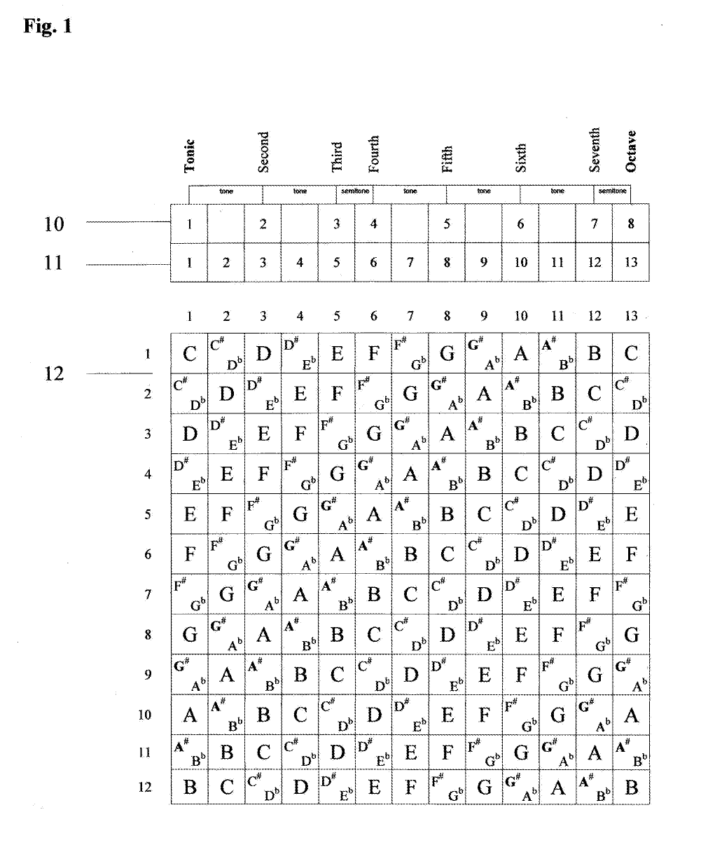

Using the diatonic scale FIG. 1 (10), one can see the Fibonacci sequence of 1, 3, 5 and 8 as being CEGC, a perfect major chord. On a chromatic scale (11), this gives us 1, 5, 8, 13, except for skipping the 3, the Fibonacci sequence still applies. Starting on any key, the spacing is always the same as can be seen in the bottom part of the table (12) whether one starts with a C or an F.

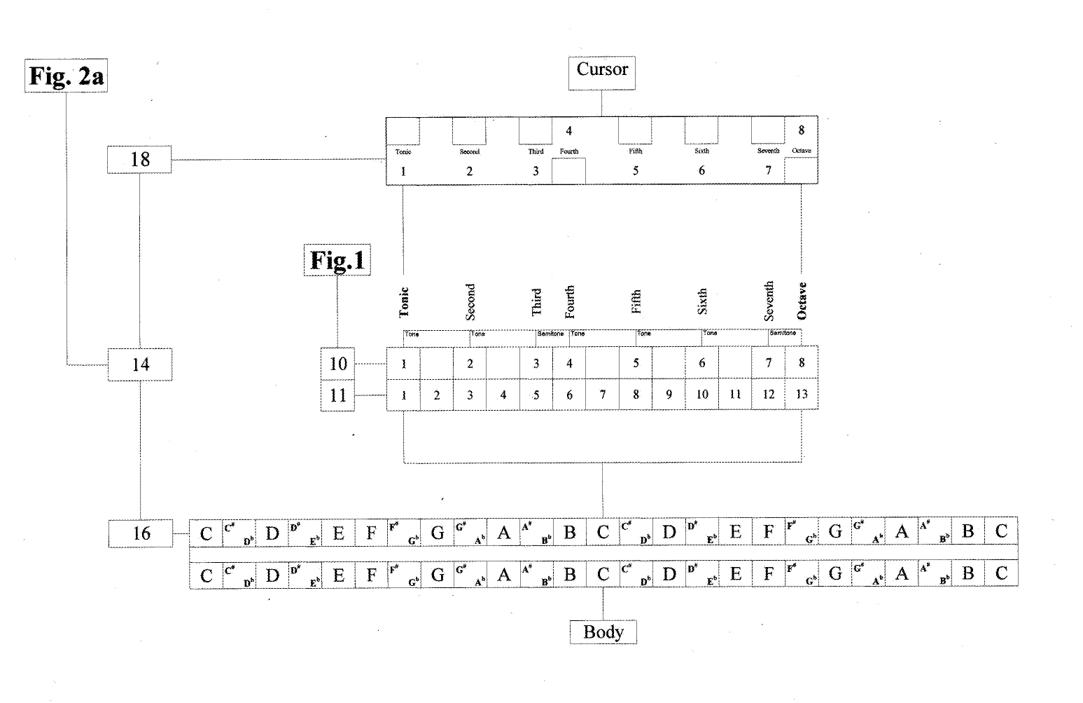

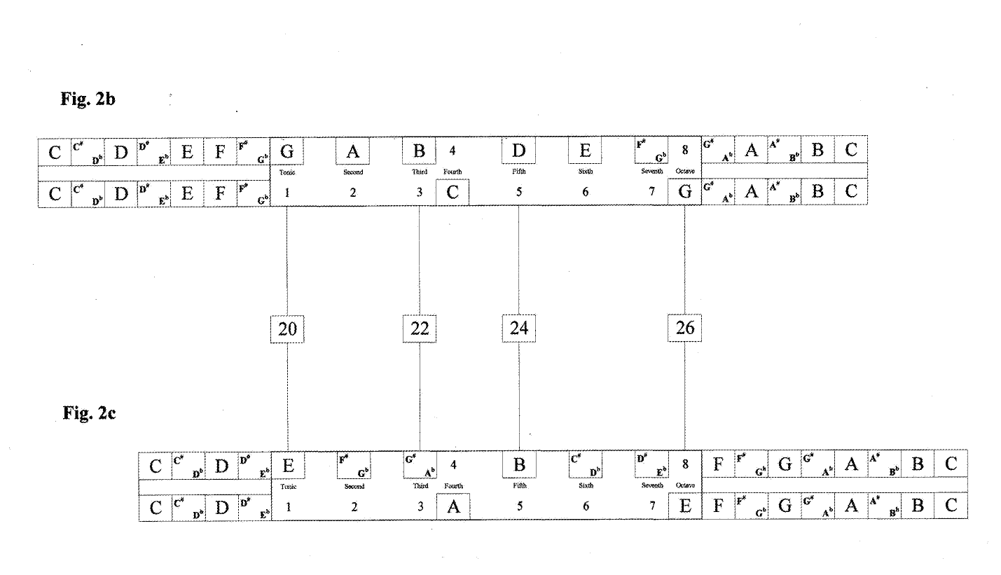

This makes it easy to create a slide rule FIG. 2a (14) with a body (16) and only one cursor (18) with windows (20, 22, 24, 26) As can be seen on FIG. 2b, the cursor (18) is positioned on G (20) which means that the following would be a B (22) followed by a D (24) and the octave a G (26).

FIG. 2c shows that by sliding the cursor (18) to the letter E (20) which means that the following would be a G#/A^{b} (22) followed by a B (24) and the octave a E (26).

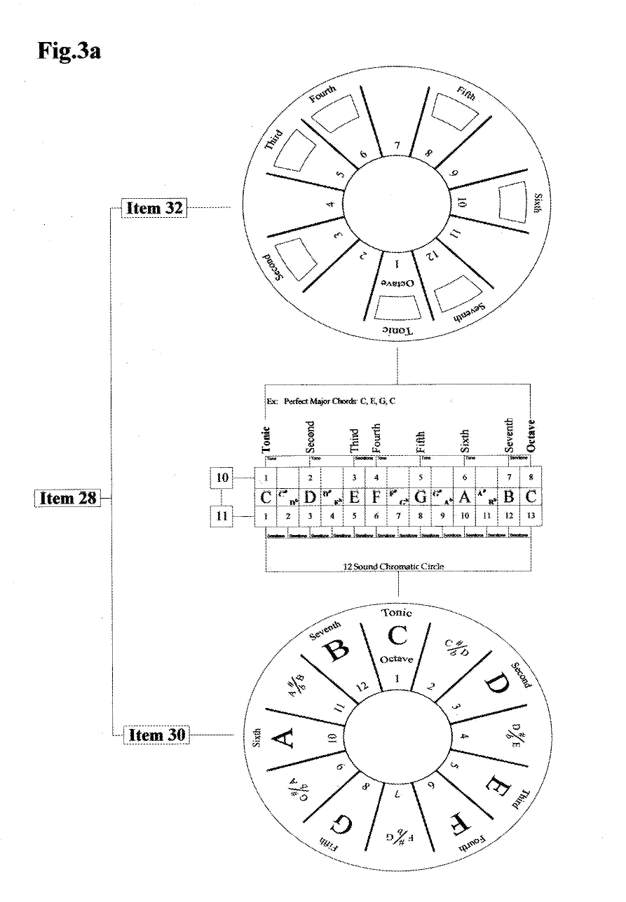

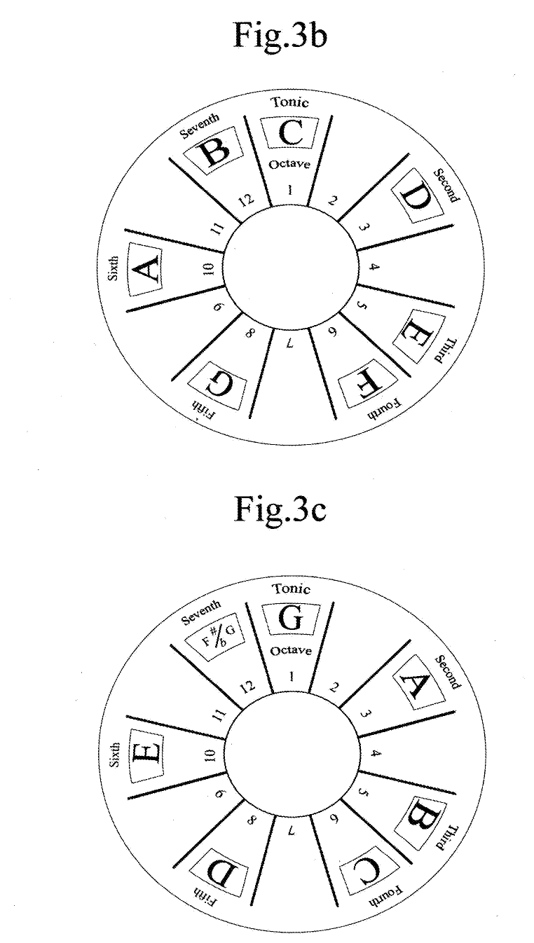

The same principle applies with the wheel FIG. 3a (28) which has a fixed disc (30), a rotating disc (32) and windows (20′) located on the rotating disc (32). Which shows CEGC in FIG. 3b and GBDG in FIG. 3c.

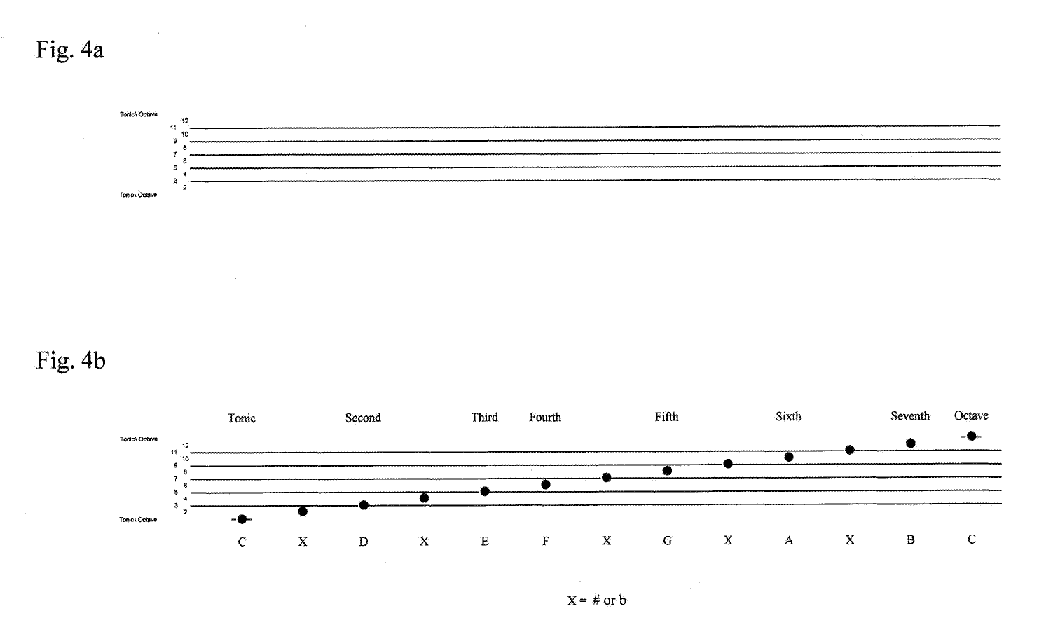

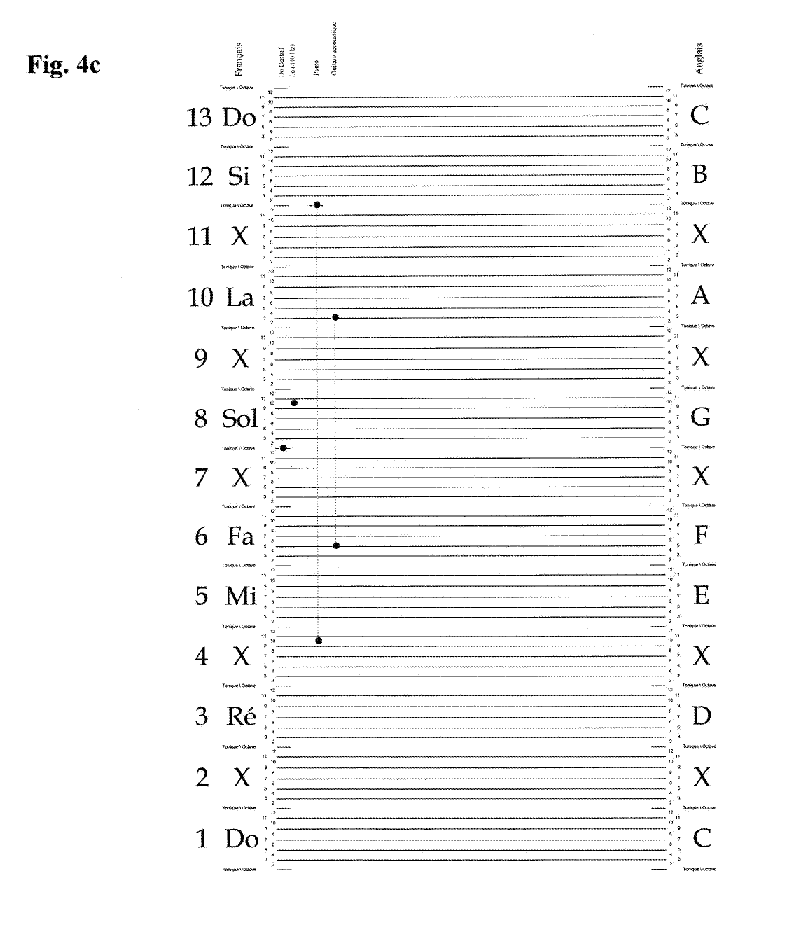

The same technique is apply when transcribing music using the chromatic scale on a standard staff FIG. 4a the notation is disposed as per FIG. 4b. This technique creates a new musical standard in all different keys whatever in F or G . . . FIG. 4c shows a new universal musical notation scale.

Simply put, the method consists in using the 12 chromatic tones scale as a foundation to obtain a string of numbers which gives the proper musical interval or sequence—whether a physical spacing such as on the slide rule of FIG. 2 or the wheel FIG. 3. This becomes a virtual spacing or sequence as one would be used when transcribing music or modeling an electronic version embodied in the form of a pocket calculator, like hand held tool or as a piece of software embedded into a musical instrument or in a personal computer. That spacing or sequence indicates the location of the notes.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A musical conversion system comprising:
an embodiment enabling the transformation of musical chords and transcribing the chords or music to different keys.

2. A musical conversion system as in claim 1 having a mode of operation described by the following sequence:
using Fibonacci's sequence of 1, 3, 5, 8, and 13 on a western conventional musical scale;
using any key, the spacing between physical notes on a sheet of music or musical instrument is always the same.

2. A musical conversion system as in claim 1 that can be embodied into a structure wherein:
said structure is a table.

3. A musical conversion system as in claim 1 that can be embodied into a structure wherein:
said structure is a slide rule.

4. A musical conversion system as in claim 1 that can be embodied into a structure wherein:
said structure is a rotary wheel.

5. A musical conversion system as in claim 1 that can be embodied into a structure wherein:
said structure is a hand held electronic calculator.

6. A musical conversion system as in claim 1 that can be embodied into a structure wherein:
said structure is a computer hardware with software written according to the musical conversion system.

7. A musical conversion system as in claim 1 having the method of use consisting of the steps of: using the 12 chromatic tones scale as a foundation to obtain a string of numbers which gives the proper musical interval or sequence;
this becomes a virtual spacing or sequence as one would be used when transcribing music or modeling an electronic version embodied in the form of a pocket calculator, like hand held tool or as a piece of software

8. A musical conversion system as in claim 1 in the form of a slide rule having the method of use consisting of the steps of:
starting on any key, the spacing is always the same on the slide rule with a body and a cursor;
the cursor is positioned on a user selected note which automatically positions the other windows located on the cursor to show the other notes of the chord which are located on the body.

9. A musical conversion system as in claim 1 in the form of a rotary wheel having the method of use consisting of the steps of:
starting on any key, the spacing is always the same on the wheel with a fixed disc and a rotating disc;
the rotating disc is positioned on a user selected note which automatically positions the other windows to show the other notes of the chord which are located on the fixed disc.

10. A musical conversion system comprising:
an embodiment enabling the transformation of musical chords and transcribing the chords or music to different keys;
the embodiment enables the use of Fibonacci's sequence of 1, 3, 5, 8, and 13 on a western conventional musical scale and;
by selecting a musical note, the remaining notes of the chord are indicated on the embodiment which instantly gives the correct notes for the newly selected key the piece of music is to be played.
